(19) United States
(12) Patent Application Publication
(10) Pub. No.: US 2006/0236973 A1
(43) Pub. Date: Oct. 26, 2006

(54) ACTIVE INTAKE MUFFLER

(75) Inventors: Oliver Seibt, Paderborn (DE); Graham Bush, Troy, MI (US)

Correspondence Address: HENRY M FEIEREISEN, LLC, 350 FIFTH AVENUE, SUITE 4714, NEW YORK, NY, 10118, US

(73) Assignee: Benteler Autmobiltechnik GmbH, Paderborn (DE)

(21) Appl. No.: 11/380,102

(22) Filed: Apr. 25, 2006

(30) Foreign Application Priority Data
Apr. 25, 2005 (DE) 10 2005 019 459.1

(51) Int. Cl. F02M 35/12; F02M 35/14; F01N 1/06

(52) U.S. Cl. 123/198 E; 181/206

(57) ABSTRACT

An active intake muffler for an air intake duct of an internal combustion engine includes a control unit, a sensor assembly operatively connected to the control unit, and a diaphragm constructed to be resistant to heat and moisture. The diaphragm is acoustically coupled with a flow of intake air in the air intake duct and has a surface which confronts the flow of intake air. A transducer is operated by the control unit for causing the surface of the diaphragm to vibrate in a bending vibration mode to thereby produce a structure-bone sound in dependence on noise caused by the intake of air.

### CROSS-REFERENCES TO RELATED APPLICATIONS

This application claims the priority of German Patent Application, Serial No. 10 2005 019 459.1, filed Apr. 25, 2005, pursuant to 35 U.S.C. 119(a)-(d), the content of which is incorporated herein by reference.

Reference is also made to commonly assigned copending patent application by the same inventive entity, entitled “Active Exhaust-Noise Attenuation Muffler”, Appl. No. 11/373,831, filed Mar. 10, 2006, the disclosure of which is incorporated herein by reference.

### BACKGROUND OF THE INVENTION

The present invention relates, in general, to an active intake muffler for an air intake duct of an internal combustion engine.

Nothing in the following discussion of the state of the art is to be construed as an admission of prior art.

Air induction systems of motor vehicles typically include an intake muffler to reduce the intensity of noise, caused by intake of combustion air into the internal combustion engine, to an acceptable level. Regulations provide hereby a legal standard for noise reduction.

Passive mufflers operate on the basis of sound absorption and include fibrous or open-pored materials having large and greatly structured surfaces. In this way, air intake noise is diverted and reflected in absorbing and sound-suppressing mazes so that the noise energy is reduced until the air intake noise drops below a desired level. These types of passive mufflers retain the intake air so that engine performance is adversely affected. Other types of intake mufflers operate on the utilization of a countersound to superpose on the disturbing noise with a compensation sound having a same frequency and intensity as the disturbing noise but being phase-shifted by 180°. As a result of the interference, the disturbing noise is attenuated. Countersound may be produced passively by particularly constructed resonators and actively by loudspeakers. Resonators may be configured as λ/4 pipe and coupled to the side of the air intake duct. Sound is reflected phase-shifted by 180° at the end of the λ/4 pipe. Reflecting sound waves superpose on the disturbing noise to effect the noise attenuation. As a consequence of the time that is required for the sound to travel twice along the length of the λ/4 pipe and due to dynamic conditions that result in a change in frequency of the air intake noise in the air intake ducts, the superimposition with the reflected sound fails to realize the desired compensation. Moreover, the frequencies where complete suppression is possible are limited to a multiple of λ/4 for physical reasons.

In view of these limitations, the use of active intake mufflers has been developed which are equipped with a secondary sound source to produce a compensation sound by means of loudspeakers. For purposes of generating the compensation sound, control circuits and closed loops have been used. The control circuits include sensors to ascertain relevant parameter for the air intake noise, like e.g. motor speed, load state of the motor, intake air temperature. A control unit generates output signals in response to incoming input signals to operate the loudspeaker disposed on the air intake duct. The use of a closed loop is able to further enhance sound reduction by complementing the sensor assembly with a pressure sensor or microphone. In response to the air intake noise ascertained by the sensor assembly, the control unit is then able to generate jointly with the loudspeaker a compensation sound which is suited to the dynamic changes of the air intake noise.

Establishing physical parameter in connection with reduction of air intake noise is very difficult. As noted above, air intake noise has a high sound pressure level, whereby the air intake stream pulsates. The installation space in the engine room is hot and moist. Conventional cone loudspeakers used heretofore for attenuating air intake noise are unable to cope with the rough physical conditions. In other words, the diaphragm and magnets wear off quickly. A proposal to use diaphragms of titanium has been discarded because of the prohibitively expensive costs for mass production. In order to generate low frequencies, large-area diaphragms and heavy magnets are required which however are too bulky for installation in the available space in motor vehicles and unsuitable for large-scale production in view of their weight.

It would therefore be desirable and advantageous to provide an improved active intake muffler which obviates prior art shortcomings and which is compact in structure and reliable in operation regardless of the type of vehicle involved.

### SUMMARY OF THE INVENTION

According to one aspect of the present invention, an active intake muffler for an air intake duct of an internal combustion engine includes a control unit, a sensor assembly operatively connected to the control unit, a diaphragm constructed to be resistant to heat and moisture and acoustically coupled with a flow of intake air in the air intake duct, with the diaphragm having a surface which confronts the flow of intake air, and a transducer operated by the control unit for causing the surface of the diaphragm to vibrate in a bending vibration mode so as to produce a structure-borne sound in dependence on noise caused by intake of air.

The present invention resolves prior art problems by superimposing the air intake noise with the compensation sound of a loudspeaker which operates as electroacoustic transducer on the basis of bending waves. Loudspeakers of this type have a diaphragm with a surface on which bending waves and shear waves can propagate when caused to vibrate by a transducer. The wave propagation in diaphragms may be realized in many ways. In thicker diaphragms, compact waves and dilatational waves are dominant, whereas thinner media have in addition bending and shear waves. Excitation of bending waves has been shown suitable for application in loudspeakers in view of their amplitude and their propagation performance. The propagation performance of bending waves in a diaphragm is primarily impacted by the bending stiffness of the diaphragm, with the bending stiffness being frequency-dependent. In the so-called coincidence frequency, the phase velocity of the wave in the diaphragm matches the phase velocity in air. At this frequency, the wave separates from the diaphragm at an angle of about 0°. Above the coincidence frequency, the angle increases up to 90°, thereby abruptly increasing the efficiency. The coincidence frequency thus constitutes the lowest frequency at which the bending waves can be converted into air sound waves. Below this frequency, the diaphragm vibrates predominantly in a piston-like manner.

Loudspeakers of this type can be made flat. The diaphragm is thin and can be made planar or slightly curved. A flat configuration of the diaphragm significantly simplifies a calculation of bending waves and the overall configuration of the diaphragm. In addition, larger diaphragms can be made more compact and may be disposed, for example, in close proximity to the air intake duct.

According to another feature of the present invention, the transducer can be secured to the backside of the diaphragm and coupled therewith. The diaphragm may suitably held in a frame of the housing of the loudspeaker. Suitably, the housing is disposed on the intake air distal side of the diaphragm in surrounding relationship to the transducer.

According to another feature of the present invention, the diaphragm is constructed to be able to withstand physical impacts in the air intake duct. In particular, the diaphragm should be able to resist temperature and moisture. In addition, the diaphragm should be airtight.

The loudspeaker is operated by the control unit which is operatively connected to the sensor assembly via signal lines. The intake muffler can thus be constructed with a control circuit as well as a closed loop in order to actively and efficiently reduce air intake noise.

According to another feature of the present invention, the diaphragm may be disposed in an opening in a wall of the air intake duct. Suitably, the diaphragm may be disposed in an air filter unit or an air collecting housing. As a result, the intake muffler is compact through integration in an existing component. As a result of the direct linkage of the loudspeaker with the air intake flow, attenuation is significantly simplified because fewer factors need to be taken into account to generate the countersound.

According to another feature of the present invention, the diaphragm may be made of a stainless steel foil. In this way, the resistance of the diaphragm is enhanced and the diaphragm is able to cope with the rough physical demands.

According to another feature of the present invention, the intake air confronting surface of the diaphragm may be coated with metal through a vapor deposition process. As an alternative, it is also possible to apply a stainless steel foil upon the intake air confronting surface of the diaphragm. In either approach, the resistance of the diaphragm is enhanced and the diaphragm can be produced from cost-efficient material.

The air intake noise is substantially influenced by the motor, i.e. speed level and load state as well as by the temperature of the air intake flow. Thus, it may be suitable to operatively connect the control unit with an electronic motor control system. The direct link enables a continuous transmission of motor data during operation to the control unit, without requiring complex signal conversion processing with resultant decrease in efficiency and loss in time. Suitably, respective interfaces are provided at the output of the electronic motor control system and at the input of the control unit.

According to another feature of the present invention, the sensor assembly may include a temperature sensor for measuring a temperature of the intake air in the air intake duct. As the speed of sound is dependent especially on the temperature of the intake air, consideration of the intake air temperature significantly enhances the efficiency of the intake muffler.

According to another feature of the present invention, the sensor assembly may include a throttle sensor for determining a throttle position. The arrangement of a throttle sensor provides inference about the load state of the motor. Sensors of this type are typically used in current motor vehicles and their structure and operation are generally known to the artisan.

According to another feature of the present invention, the sensor assembly may include a speed sensor for determining a motor speed.

According to another feature of the present invention, the sensor assembly may include a pressure sensor, e.g. a microphone, for determining the air intake noise in the air intake duct. Provision of a closed loop for producing the compensation sound is especially effective to attenuate air intake noise. The sensor assembly is hereby resistant to the intake air in a same manner as the loudspeaker.

According to another feature of the present invention, a microprocessor may be provided for control of the control unit. This affords flexibility to adapt the intake muffler to various situations at hand. The control performance of the control unit is program-controlled. The programs may be modified or exchanged via a respective interface on the control unit. In this way, intake air noise can be configured like a sound design. A microprocessor-controlled control unit further simplifies the installation of the intake muffler independent from the motor vehicle because it is only required to suit the software while the hardware can remain the same.

According to another feature of the present invention, the control unit may be constructed to allow adjustment of the control performance. As a result, the operator is able at any time to directly influence the noise of the vehicle by actuating switches or variable transformers. In other words, the noise can be adjusted by the operator to sound especially racy or gentle.

According to another feature of the present invention, the transducer may be constructed as an oscillation coil. Use of an oscillation coil results in a compact configuration and arrangement of few moving parts. As an alternative, the transducer may include an electric motor having a driveshaft, with an eccentric secured to the driveshaft and coupled to the diaphragm via a connecting rod. In this way, the frequency of the vibrating diaphragm can be adjusted in an especially easy and robust manner. The electric motor may be placed separate and away from the intake air flow, thereby significantly decreasing the exposure of the transducer to thermal stress. In addition, the transducer may be constructed heat-resistant.

According to another feature of the present invention, a housing may be provided for accommodating the diaphragm and the transducer. The provision of a housing serves two purposes, namely as protection from the environment, and facilitation of the assembly because the transducer together with the diaphragm and the housing can be constructed as a prefabricated unitary structure that can be shipped as a unit for assembly.

### BRIEF DESCRIPTION OF THE DRAWING

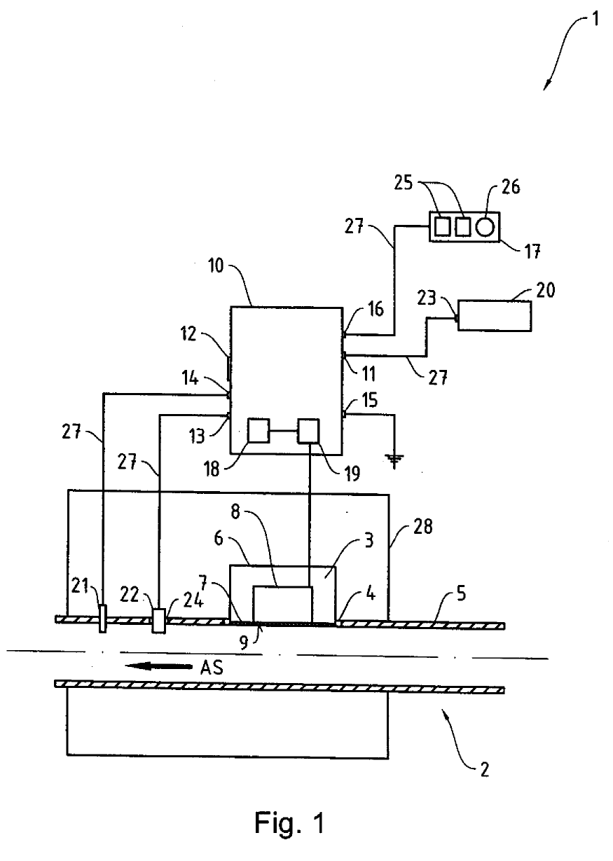

Other features and advantages of the present invention will be more readily apparent upon reading the following description of currently preferred exemplified embodiments of the invention with reference to the accompanying drawing, in which the sole FIGURE 1 is a partial longitudinal section of an active intake muffler according to the present invention.

### DETAILED DESCRIPTION OF PREFERRED EMBODIMENTS

The depicted embodiment is to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

Turning now to FIG. 1, there is shown a partial longitudinal section of an active intake muffler according to the present invention, generally designated by reference numeral 1, for an air intake duct 2 that may find application for example in a motor vehicle and is arranged in an air filter unit 28. The active intake muffler 1 is provided to superpose the noise, caused by intake of combustion air into internal combustion engine, with a 180° phase-shifted compensation sound of a loudspeaker 3 so as to reduce or suppress the air intake noise.

The loudspeaker 3 has a flat configuration and is placed in a lateral opening 4 in the wall 5 of the air intake duct 2 of an unillustrated motor. The loudspeaker 3 has a diaphragm 7 and a transducer which is implemented by way of example in the form of an oscillation coil 8. Both, the diaphragm 7 and the oscillation coil 8 are arranged in a housing 6. The diaphragm 7 is thin and can be made of a stainless steel foil so as to exhibit a particularly low coincidence frequency and a broad frequency spectrum within which the diaphragm 7 is able to vibrate so as to generate a structure-bone sound. The diaphragm 7 is made resistant to heat and moisture 7. This can be achieved by vapor-depositing a metal on an intake air confronting surface 9 of the diaphragm 7. As an alternative to the vapor-deposition of metal, the application of a stainless steel foil upon the intake air confronting surface 9 of the diaphragm 7 is also conceivable.

The diaphragm 7 is so aligned in the opening 4 such that the intake air confronting surface 9 contacts the intake air flow AS. Secured to the backside of the diaphragm 7 is the oscillation coil 8 which, when excited, causes the diaphragm 7 to vibrate. As a result, bending waves are able to propagate on the air intake confronting surface 9 of the diaphragm 7. The oscillation coil 8 is also resistant to heat and moisture. The loudspeaker 3 has enough potential to produce a compensation sound of necessary intensity.

The loudspeaker 3 is operated by a microprocessor-controlled control unit 10 which is mounted in an unillustrated vehicle body of the motor vehicle at a separate location. The control unit 10 has various interfaces 11-16, with reference numeral 11 relating to an interface for an electronic motor control system 20 forming part of a sensor assembly, reference numeral 12 relating to an interface for data transfer, reference numeral 13 relating to an interface for input of a microphone 22 forming another part of the sensor assembly, reference numeral 14 relating to an interface for a temperature sensor 21 forming yet another part of the sensor assembly, reference numeral 15 relating to an interface for a voltage supply, and reference numeral 16 relating to an interface for a control panel 17. In response to the signals transmitted by the sensor assembly via signal lines 27, the control unit 10 computes a compensation vibration which is converted by a digital-to-analog converter 18 into an electric oscillation and boosted by an amplifier 19 of the control unit 10 before being delivered to the loudspeaker 3. Computation of the compensation vibration is program-controlled, with the programs being exchangeable via the data transfer interface 12. Each vehicle type has its own particular program. The control performance of the control unit 10 may be modified by an operator using the control panel 17 in order to give the vehicle a racy or gentle sound or to make the vehicle noise quieter or louder.

The control unit 10 is directly linked to the sensor assembly comprised of the electronic motor control system 20, temperature sensor 21, and microphone 22, whereby the temperature sensor 21 and the microphone 22 are mounted to the air intake duct 2. Signal transfer takes place via the signal lines 27. The electronic motor control system 20 transmits information about the speed and load state of the motor from a particular output interface 23 to the control unit 10. The temperature sensor 21 ascertains a temperature of the intake air flow AS in the air intake duct 2 in close proximity of the loudspeaker 3 and is constructed resistant to intake air. The microphone 22 is also constructed resistant to intake air and disposed upstream of the loudspeaker 3 in an opening 24 in the wall 5 of the air intake 2.

In order to modify the sound of the vehicle, the driver uses the operating panel 17 which is placed within easy reach of the driver during travel. The operating panel 17 includes switches 25 and a variable transformer 26 and is linked to the control unit 10 via a signal line 27.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. An active intake muffler for an air intake duct of an internal combustion engine, comprising:
a control unit;
a sensor assembly operatively connected to the control unit;
a diaphragm constructed to be resistant to heat and moisture and acoustically coupled with a flow of intake air in the air intake duct, said diaphragm having a surface which confronts the flow of intake air; and
a transducer operated by the control unit for causing the surface of the diaphragm to vibrate in a bending vibration mode so as to produce a structure-borne sound in dependence on noise caused by intake of air.

2. The intake muffler of claim 1, wherein the diaphragm is disposed in an opening in a wall of the air intake duct.

3. The intake muffler of claim 1, further comprising an air filter unit, said diaphragm being disposed in the air filter unit.

4. The intake muffler of claim 1, further comprising an air collecting housing, said diaphragm being disposed in the air collecting housing.

5. The intake muffler of claim 1, wherein the diaphragm is flat.

6. The intake muffler of claim 1, wherein the diaphragm is made of a stainless steel foil.

7. The intake muffler of claim 1, wherein the surface of the diaphragm is coated with metal through a vapor deposition process.

8. The intake muffler of claim 1, further comprising a stainless steel foil applied upon the surface of the diaphragm.

9. The intake muffler of claim 1, further comprising an electronic motor control system operatively connected to the control unit.

10. The intake muffler of claim 1, wherein the sensor assembly includes a temperature sensor for measuring a temperature of the intake air in the air intake duct.

11. The intake muffler of claim 1, wherein the sensor assembly includes a throttle sensor for determining a throttle position.

12. The intake muffler of claim 1, wherein the sensor assembly includes a speed sensor for determining a motor speed.

13. The intake muffler of claim 1, wherein the sensor assembly includes a pressure sensor for determining the air intake noise in the air intake duct.

14. The intake muffler of claim 13, wherein the pressure sensor is a microphone.

15. The intake muffler of claim 1, further comprising a microprocessor for controlling the control unit.

16. The intake muffler of claim 1, wherein the control unit includes an amplifier for boosting a signal received from the sensor assembly.

17. The intake muffler of claim 1, wherein the control unit is constructed to allow adjustment of a control performance.

18. The intake muffler of claim 1, wherein the transducer is an oscillation coil.

19. The intake muffler of claim 1, wherein the transducer includes an electric motor having a driveshaft, and further comprising an eccentric coupled to the diaphragm via a connecting rod.

20. The intake muffler of claim 1, wherein the transducer is constructed to be heat-resistant.

21. The intake muffler of claim 1, further comprising a housing for accommodating the diaphragm and the transducer.

22. The intake muffler of claim 21, wherein the housing is disposed on an intake air distal side of the diaphragm in surrounding relationship to the transducer.

23. The intake muffler of claim 1, wherein the transducer is secured to a backside of the diaphragm.

24. The intake muffler of claim 1, wherein the compensation sound is 1800 phase-shifted to the intake air noise.

25. The intake muffler of claim 1, wherein the diaphragm is constructed to conform to a contour of a wall of the exhaust pipe.
